(19) United States
(12) Patent Application Publication
(10) Pub. No.: US 2007/0076943 A1
(43) Pub. Date: Apr. 5, 2007

(54) Method and apparatus for inspecting a wafer

(75) Inventors: Joachim Wienecke, Jena (DE); Detlef Wolter, Jenapriessnitz (DE)

Correspondence Address: SIMPSON & SIMPSON, PLLC, 5555 MAIN STREET, WILLIAMSVILLE, NY, 14221-5406, US

(73) Assignee: Vistec Semiconductor Systems Jena GmbH, Jena (DE)

(21) Appl. No.: 11/400,919

(22) Filed: Apr. 10, 2006

(30) Foreign Application Priority Data
Apr. 15, 2005 (DE) 10 2005 017 642.9

(51) Int. Cl. G06K 9/00

(52) U.S. Cl. 382/145

(57) ABSTRACT

The present invention provides a method for inspecting the surface of a wafer, wherein an image of a wafer recorded by a camera is evaluated with respect to the imaging quality and is taken again, if necessary, before the wafer is evaluated by evaluating the image.

### CROSS REFERENCE TO RELATED APPLICATIONS

This application claims priority of German Patent Application DE 10 2005 017 642.9, filed Apr. 15, 2005, which application is incorporated herein by reference.

### FIELD OF THE INVENTION

The present invention relates to a method for inspecting the surface of a wafer wherein the wafer is evaluated by evaluating an image of the wafer.

### BACKGROUND

A method of this type is known from DE 103 07 454 A1. In this method an image having pixels is recorded on the surface of a wafer. A frequency distribution of the color values is calculated from the color values of the pixels. The frequency distribution thus calculated is compared with a stored frequency distribution, and the quality of the surface of the wafer is evaluated as a result. In some cases there are errors in imaging, the cause of which can be found in each individual case only with great difficulty.

A drawback in the prior art is that errors in imaging are interpreted as defects on the wafer.

### SUMMARY OF THE INVENTION

It is therefore an object of the present invention to further develop the method of the initially mentioned type in such a way that defective images of the wafer are automatically detected and corrected.

The present object is achieved by a method for inspecting the surface of a wafer, comprising the steps of:
recording an image of a wafer;
automatically evaluating the image;
if necessary renewed recording of the image of the wafer automatically as a function of the evaluation; and,
evaluating the image for inspecting the wafer.

According to the invention the object is achieved in a method for inspecting the surface of a wafer with the following process steps: taking an image of the wafer; automatically evaluating the image; if necessary, renewed imaging of the wafer automatically as a function of the evaluation; and evaluating the image for inspecting the wafer.

The imaging step involves illuminating with the aid of an illumination means and imaging the wafer in a camera. The illumination can be carried out continuously or in a pulsed manner in synchronism with the imaging.

Accordingly, the invention provides a method for inspecting the surface of a wafer wherein an image of a wafer taken by a camera is evaluated with respect to the imaging quality and is taken again, if necessary, before the wafer is evaluated by evaluating the image.

This is advantageous in that the wafer is repeatedly imaged, if necessary, until a useful image is available for evaluating the wafer. Moreover, the operator of the assembly in question is not made insecure with respect to the quality of the arrangement by the sometimes occurring defective images.

Preferably it is provided that the evaluation comprises comparing the image with a reference image.

This is advantageous in that the evaluation can be carried out in a simple manner and by using a reference image which is used anyway for subsequent evaluation of the wafer.

Suitably the image is taken as partial images.

This is advantageous in that the size of the partial images can be optimally adapted to the camera's resolution and the optics.

The partial images correspond to a stepper illumination area also called a stepper area window (SAW), and they comprise a portion, one or more dies or semiconductor elements.

The whole image is initially completely recorded in partial images, and the evaluation or the histogram for the evaluation is formed from the overall combined image or the sum of the partial images. The evaluation of the overall combined image is advantageous in that errors arising in the combining step can be detected by the evaluation.

Suitably it is provided that in the evaluation the histogram of the image is compared with a reference histogram.

This is advantageous in that the evaluation can be rapidly carried out since the histogram represents a substantially reduced and quantitatively comparable data set of an image. As a result the inspection of the wafer is carried out more rapidly and is more cost-effective due to the smaller computer power needed.

A histogram is a frequency distribution of pixels of a similar kind.

The histogram of the image can also be a histogram of a difference image. The difference image is generated by subtracting the reference image from the image for the individual pixel values. The reference histogram used for the difference image will then only contain zero values. The comparison is already present as the histogram of the difference image.

According to an embodiment of the invention it is provided that the histogram is a gray-scale or color-value histogram.

In a gray-scale histogram a plurality of areas of brightness values from black in shades of gray to white have their frequency allocated to corresponding pixels or image areas of the overall image. The brightness values can be chosen, for example, as the sum of the intensities of the three channels of the RGB color space or the luminance Y of the YUV color space. Usually, 256 gray-scale values from black to white are selected. In a color-value histogram a plurality of areas of color coordinate values have their frequencies allocated to corresponding pixels or image areas. The brightness values of individual color channels, such as red, green or blue, of the RGB color space or the chrominance U or V or the YUV color space can be chosen as the color coordinate values. This corresponds to a gray-scale value histogram for a color channel. Combinations or ratios of color percentages can also be chosen, however, as color coordinate values.

According to the preferred embodiment of the invention it is provided that only a bright and/or dark-end range of the histogram is compared.

This is advantageous in that the data amounts to be compared are reduced and therefore the computer power needed is minimized, and the processing speed is increased. As a result the wafer is inspected more quickly and in a more cost-effective way.

Experiments have shown that the typical imaging errors, such as absence of illumination of the image or of a partial image or defective combination of partial images in an image, cause particularly bright or particularly dark brightness values to be added to the partial image or image, or to be absent from it, in a significant manner. This is why it is sufficient to determine these increased or reduced bright or dark brightness values to detect a defective image. In contrast, the histogram of an error-free image of a defective wafer shows a slight deformation of the overall histogram or a deformation in particular in the center of the histogram.

Advantageously it is provided that the reference histogram is obtained from the image of a reference wafer. This is done in a learning phase, before a wafer to be inspected is imaged.

Advantageously it is provided that the reference histogram is obtained by averaging the histograms of images of a plurality of wafers. This is done in a learning phase, before a wafer to be inspected is imaged.

This is advantageous in that the reference histogram is not characterized by a random feature of an individual wafer since random individual errors of the individual wafers are eliminated by averaging.

Suitably it is provided that the re-imaging depends on one or more predefined threshold values.

This is advantageous in that certain deviations of the image from the reference image are tolerated, and there is no erroneous detection of a defective image.

The threshold values can be modified by an operator via an input device, or can be learnt by indicating good and defective images.

The evaluation of the image is therefore carried out using the following steps: creating a histogram from the image at least for the areas at the bright and/or dark end of the spectrum; subtracting the analog areas from the histogram and the reference histogram; comparing whether each absolute difference value exceeds the threshold values; if the threshold values are exceeded, evaluating the image as defective; and causing the image to be re-imaged.

It is advantageously provided for the image to be a partial image of the wafer.

Recording of a partial image is thus evaluated as to whether or not the partial image is defective. It is only hereafter that the next partial image is recorded or the partial images are combined to form the overall image.

This is advantageous in that the imaging errors of a partial image can be immediately corrected by re-imaging and in that the whole imaging process for the wafer does not have to be repeated.

In this case the evaluation of the image for evaluating the wafer can also comprise the combination of the partial image to form the overall image.

It is particularly advantageous for the evaluation of the image for inspecting the wafer to be carried out as a function of the evaluation of the image.

For example, the histogram of the image or of a partial image created for evaluation can be used for the subsequent evaluation of the wafer. As a result, the histogram does not have to be created again.

This is advantageous in that the processing results in the evaluation of the image, which can be reused when the wafer is evaluated, does not have to be created again for the evaluation. As a result the method can be carried out more rapidly, using less computer power and therefore in a more cost-effective way.

The advantages mentioned for the individual embodiments of the invention are not exhaustive and do not necessarily represent the actual principal advantages.

### BRIEF DESCRIPTION OF THE DRAWINGS

The invention will be explained in more detail in the following with reference to schematic views of the drawings. The same elements are indicated by the same reference numerals throughout the drawings, in which:

FIG. 1 is a schematic overview of the apparatus for inspecting a wafer;

FIG. 2 is a combined image of a wafer;

FIG. 3 is a combined image of a wafer with an imaging error;

FIG. 4 is a combined image of a wafer with another imaging error;

FIG. 5 shows a reference histogram of a reference wafer;

FIG. 6 shows a histogram of a wafer; and,

FIG. 7 is a comparison of the histogram with the reference histogram.

### DETAILED DESCRIPTION OF THE INVENTION

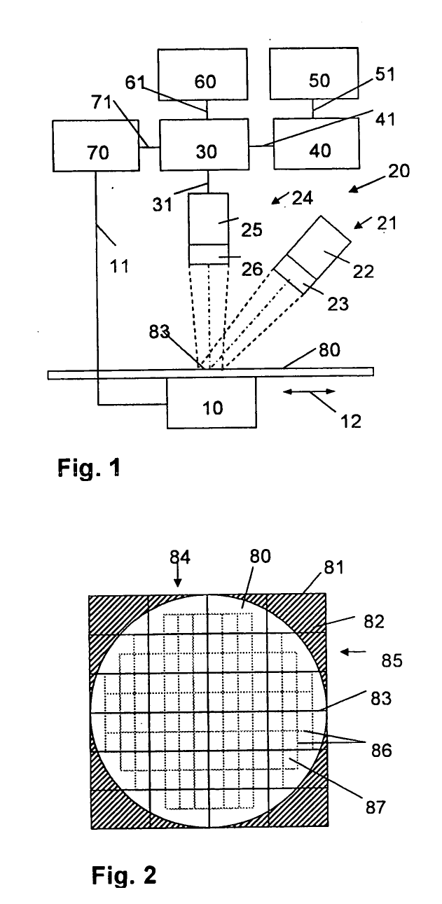

A schematic overview of the apparatus for inspecting a wafer is shown in FIG. 1.

Wafer 80 is supported by a transportation means 10. The transportation means is an X-Y traversing stage able to move the wafer in two orthogonal movement directions 12 in parallel to its extension plane. The transportation means is linked to a control means 70 via a data line 11.

The imaging means 20 comprises an illumination means 21 having a light source 22 and a lens 23, and an image detection means 24, having a camera 25 and a lens 26. The camera is usually a color CCD camera, however, it could be any other matrix camera, linear array camera or other brightness or color sensor. The camera images a partial image 83 of the wafer illuminated by the illumination means. The illumination means can be configured as a bright-field or dark-field illumination, as a broad-band, multi-band or monochromatic illumination. The image detection means is linked to an image processing means via a data link 31. The image processing means reads the camera images under the control of a control means connected to it via a data link 71, and processes them. The image processing means is connected to the storage means 40 via a data link 41. In the storage means, a reference image, a reference histogram and threshold values are stored. A reference histogram and the threshold values can be modified by the operator through an input device 50 connected to the storage means via a data line 51. The image processing means is connected to an output means 60 via a data line 61. The output means can visualize the image, partial images, histograms, the reference histogram, the threshold values or a comparison to the operator.

Under the control of the control means, the X-Y scanning stage, a so-called stepper, transports the wafer past the focus of the camera in a meandering path. This relative movement between the wafer and the camera could also be caused by a corresponding movement of the camera or by correspondingly moving the optical path of the camera optics. The movement, the illumination and the imaging are adapted to each other by the control means. The movement is carried out in thrusts separated by periods of immobility. In these periods of immobility, there is usually a flash-like illumination and the camera images a partial image using the image processing means. This partial image is stored in the memory means.

FIG. 2 shows a combined image of a wafer.

Image 81 of wafer 80 recorded by the camera and the image processing means consists of partial images 83, the so-called stepper area windows (SAWs). An outer area 82 extends between the outer edge of the wafer and the outer edge of the image and generally shows the constant background of the transportation means. The SAWs are arranged in rows 85 and columns 84 and show the un-housed semiconductor chips, the so-called dies 87, separated from each other by small separating areas 86.

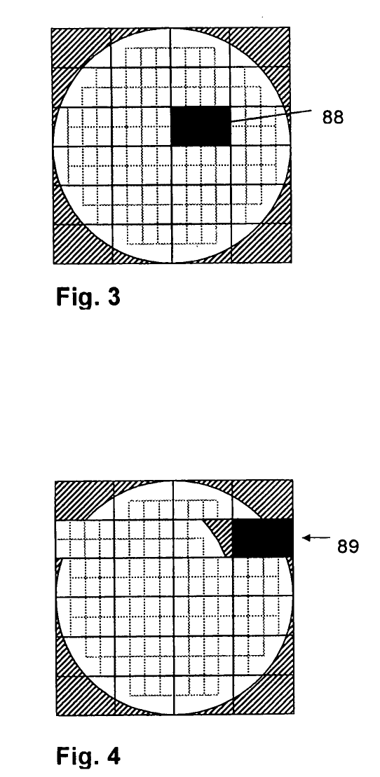

FIG. 3 shows a combined image of a wafer with an imaging error.

A defective partial image 88 can be seen among the partial images. This error may have arisen, for example, due to failure of the illumination, the camera or the image detecting means at the time of taking the image, or may be due to an error in the synchronization of the units involved.

FIG. 4 shows a combined image of a wafer with a different imaging error.

Here a defective row 89 of partial images is shown. This row is displaced to the left by one column, wherein a partial image is missing on the empty right side. Such an error can be caused by the algorithms for optimizing the camera image size with respect to the SAW size for optimizing the stepper path or for memory management.

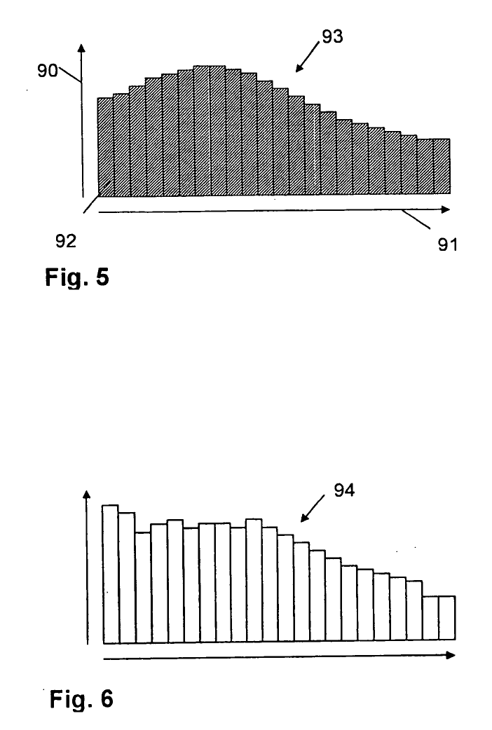

A reference histogram 93 of a reference wafer for gray-scale values is shown in FIG. 5.

The abscissa shows the brightness 91 from black on the left to white on the right; the ordinate shows the relative frequency 90. The abscissa has been subdivided in areas each having the frequency value 92 corresponding to the reference image for the brightness range associated with them. Dark median gray is most frequently present in the image. Black is a bit less frequent. Even less frequent is pure white. The histograms shown here are only schematic examples.

A histogram 94 of a wafer is shown in FIG. 6.

The frequency values for black and dark gray are increased here, those for dark median gray and also for white are reduced.

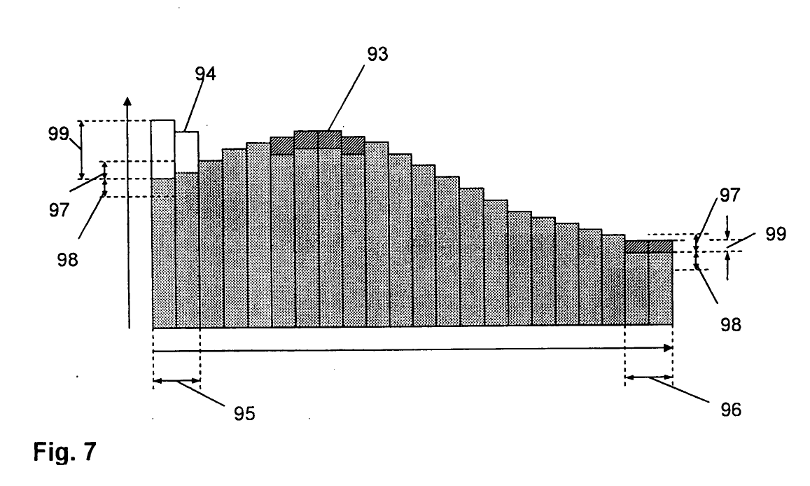

FIG. 7 shows a comparison between the histogram 94 shown in FIG. 6 and the reference histogram 93 shown in FIG. 5. Reference histogram 93, shown in a gray hatch, underlies histogram 94. In the dark-end area 95, the histogram exceeds the reference histogram. For the black brightness region the top threshold value 97 and the bottom threshold value 98 are indicated on the reference histogram. In the extreme left brightness region for black, the histogram shows a deviation 99 with respect to the reference histogram exceeding the top threshold value 97. This is the criterion for evaluating the image as defective. As a result, in the present case, the image or the partial image would have to be taken again in the method. The deviation 99 shown here could have been caused by the examples shown in FIG. 3 or FIG. 4.

In the bright-end region 96 the histogram falls short of the reference histogram. For the white brightness range, the top threshold value 97 and the bottom threshold value 98 are also indicated on the reference histogram. In the extreme right brightness range for white, the histogram shows a deviation 99 with respect to the reference histogram not exceeding the bottom threshold value 98. Due to this deviation alone, the image would not have been evaluated as defective. This deviation could have been caused by an error in the production of the wafer, just like the deviation of the histogram shown at the maximum of the reference histogram.

What is claimed is:

1. A method for inspecting the surface of a wafer, comprising the steps of:
recording an image of a wafer;
automatically evaluating the image;
if necessary renewing the recording of the image of the wafer automatically as a function of the evaluation; and evaluating the image for inspecting the wafer.

2. The method according to claim 1, wherein the evaluating step involves comparing the image to a reference image.

3. The method according to claim 1, wherein the recording of the image is carried out in partial images.

4. The method according to claim 1, wherein in the evaluating step the histogram of the image is compared to a reference histogram.

5. The method according to claim 4, wherein the histogram is a gray-scale or a color-value histogram.

6. The method according to claim 5, wherein only a bright and/or dark-end area of the histogram is compared.

7. The method according to claim 4, wherein the reference histogram is obtained from an image of a reference wafer.

8. The method according to claim 4, wherein the reference histogram is obtained by averaging the histograms of images of a plurality of wafers.

9. The method according to claim 1, wherein threshold values are defined on which the renewed recording is dependent.

10. The method according to claim 1, wherein the image is a partial image of the wafer.

11. The method according to claim 1, wherein the evaluation of the image for inspecting the wafer is carried out as a function of the evaluation of the image.
